(19) United States
(12) Patent Application Publication
(10) Pub. No.: US 2005/0044299 A1
(43) Pub. Date: Feb. 24, 2005

(54) SOC CAPABLE OF LINKING EXTERNAL BRIDGE CIRCUITS FOR EXPANDING FUNCTIONALITY

(76) Inventors: Chi-Yang Lin, Taipei Hsien (TW); Mike Chen, Taipei Hsien (TW)

Correspondence Address: (NAIPC) NORTH AMERICA INTERNATIONAL PATENT OFFICE, P.O. BOX 506, MERRIFIELD, VA, 22116, US

(21) Appl. No.: 10/708,399

(22) Filed: Mar. 1, 2004

(30) Foreign Application Priority Data
Aug. 21, 2003 (TW) 092123072

(51) Int. Cl. G06F 13/36; H02P 5/00; H02P 3/00; H02P 1/00

(52) U.S. Cl. 710/306

(57) ABSTRACT

An SOC has a processor, an internal high-speed bridge circuit, an internal low-speed bridge circuit, and an expansion port. The expansion port is capable of selectively being connected to an external low-speed bridge circuit for expanding functionality of the internal low-speed bridge circuit.

### BACKGROUND OF INVENTION

1. Field of the Invention

The present invention relates to a system on a chip (SOC), and more particularly, to an SOC capable of linking external bridge circuits for expanding functionality thereof.

2. Description of the Prior Art

With development of the information technology, microprocessor systems processing large amounts of data with high speed are widely used in the modern society. For example, computer systems are capable of exchanging and processing data of various images or words with high speed. Central processing units (CPUs) of the computer systems are developed to have a high operation speed of gigahertz (GHz), and are thus divided into reduced instruction set computer (RISC) CPUs and complicated instruction set computer (CISC) CPUs.

Because of the power consumption in the CISC CPUs, portable devices, such as PDAs, cellular phones and etc, tend to adopt RISC embedded systems. Please refer to FIG. 1 of a schematic diagram of an embedded system according to the prior art. An embedded system 30 includes a CPU 32, a high-speed bridge circuit 34, a low-speed bridge circuit 36, a display driving circuit 38, a monitor 39, a storage device 40, an input device 42, and an input/output port (I/O port) 44. The storage device 40 includes a volatile memory 46 and a nonvolatile memory 48. The CPU 32 is a RISC processor and has less logic computation circuits, thus being capable of reducing power consumption. The high-speed bridge circuit 34 is used to control signal transmission and data exchange between the CPU 32 and a high-speed peripheral device (such as the display driving circuit 38 and the storage device 40). The low-speed bridge circuit 36 is used to control signal transmission and data exchange between a low-speed peripheral device (such as the input device 42) and the high-speed bridge circuit 34. The display driving circuit 38 is used to output image signals, thus driving the monitor 39 to output corresponding images. The nonvolatile memory 48 (such as a flash memory) is used to store a real-time operating system (RTOS) and applications. When the embedded system 30 is shut down, the data stored in the nonvolatile memory 48 is not lost. The volatile memory 46 (such as a random access memory) is used to temporarily store computing data when executing the real-time operating system or the applications. The input device 42, such as a keyboard, a button or a digitizer, is provided for a user to input commands. In addition, the embedded system 30 further includes the I/O port 44 for outputting signals to an external device, or receiving signals from the external device. For example, the I/O port 44 can be an RS-232 serial port or a USB port.

In order to reduce power consumption of the embedded system 30, the CPU 32, the high-speed bridge circuit 34, the low-speed bridge circuit 36 and the display driving circuit 38 are integrated to an SOC 41. The embedded system 30 can be applied in a PDA A and is designed to have only one I/O port 44, such as a USB port, to connect to a digital camera supporting a USB port. However, when the embedded system 30 is applied in another PDA B, which supports printers having a USB port or an RS-232 serial port, the I/O port 44 cannot provide these I/O ports simultaneously and cannot support the I/O ports of different standards.

As the information technology develops rapidly, lifetime of the information products is shortened. The SOC developed for a certain product is usually not applicable to another kind of products. It is unavoidable for the companies offering SOC to redesign functionality of the SOC, for example redesign the high-speed bridge circuit 34 or the low-speed bridge circuit 36, so as to support different numbers of peripheral devices or different standards of peripheral devices. In other words, redesign of the SOC has increased its manufacturing costs and disadvantaged the competition thereof.

### SUMMARY OF INVENTION

It is therefore an object of the claimed invention to provide an SOC capable of linking external bridge circuits to solve the problem of the prior art.

According to the claimed invention, the SOC comprises a processor, a high-speed bridge circuit, a low-speed bridge circuit and an expansion port. The processor is used to control operation of the SOC. The high-speed bridge circuit, which is connected to the processor, is used to control signal transmission between the processor and a high-speed peripheral device connected to the high-speed bridge circuit. The low-speed bridge circuit, which is connected to the high-speed bridge circuit, is used to control signal transmission between the high-speed bridge circuit and a first low-speed peripheral device connected to the low-speed bridge circuit. The expansion port, which is connected to the high-speed bridge circuit, is used to connect to an expanding bridge circuit. The expanding bridge circuit is used to control signal transmission between the high-speed bridge circuit and at least a second low-speed peripheral device connected to the expanding bridge circuit.

It is an advantage of the present invention that the SOC has the expansion port and uses the expansion port to externally connect to the expanding bridge circuit according to the design demands of an embedded system. Therefore, the functionality of the internal low-speed bridge circuit within the SOC can be expanded, and the SOC can be applied in embedded systems of different hardware demands without changing any circuits within the SOC.

These and other objects of the claimed invention will be apparent to those of ordinary skill in the art after reading the following detailed description of the preferred embodiment that is illustrated in the various figures and drawings.

### BRIEF DESCRIPTION OF DRAWINGS

FIG. 1 is a schematic diagram of an SOC according to the prior art;

FIG. 2 is a schematic diagram of an SOC applied in an embedded system according to the present invention; and

FIG. 3 is a schematic diagram of another SOC applied in an embedded system according to the present invention.

### DETAILED DESCRIPTION

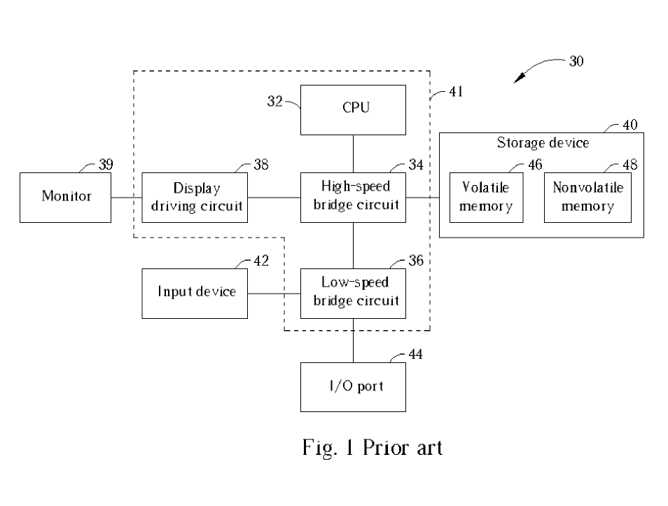

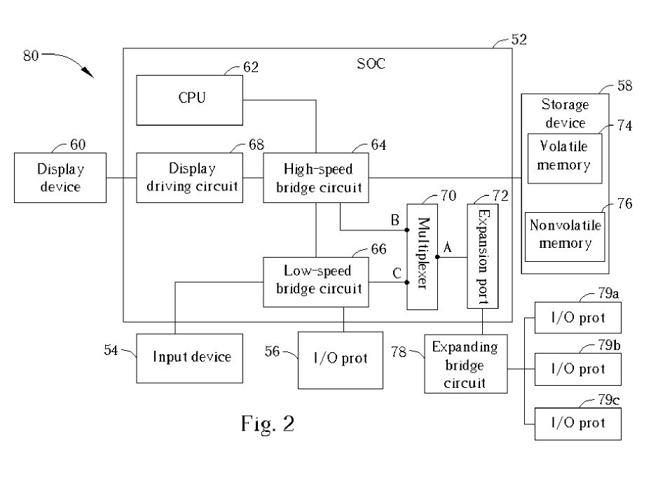

Please refer to FIG. 2 of a schematic diagram of an SOC applied in an embedded system according to the present invention. An embedded system 80 includes an SOC 52, an input device 54, an I/O port 56, a storage device 58, a display device 60, an expanding bridge circuit 78, and a plurality of I/O ports 79a, 79b, and 79c. The SOC 52 includes a CPU 62, a high-speed bridge circuit 64, a low-speed bridge circuit 66, a display driving circuit 68, a multiplexer 70, and an expansion port 72. In addition, the storage device 58 includes a volatile memory 74 and a nonvolatile memory 76. The elements having the same names in the embedded system 80 and in the embedded system 30 shown in FIG. 1 are supposed to have the same functions. The difference between the embedded system 80 and the embedded system 30 is that the expanding bridge circuit 78 is introduced into the embedded system 80 to provide the expanding I/O ports 79a, 79b and 79c. The expanding bridge circuit 78 is connected to the SOC 52 via the expansion port 72, such as the package pinouts or bailouts. The multiplexer 70 controls the expansion port 72 to select the end C to connect to the low-speed bridge circuit 66, or select the end B to connect to the high-speed bridge circuit 64 to execute data exchange and signal transmission. The embedded system 80 is capable of connecting to a plurality of external devices via the I/O ports 79a, 79b and 79c, so as to expand its functionality. For example, when the embedded system 80 is applied in a PDA (or a digital camera) and other I/O ports are required to connect to external devices, such as a printer, the multiplexer 70 is driven to connect the end A and the end B, and the expansion port 72 is also connected to the expanding bridge circuit 78. As a result, the three I/O ports 79a, 79b and 79c can be obtained via the expanding bridge circuit 78. When the SOC 52 controls the multiplexer 70 to connect the end A and the end C, the external expanding bridge circuit 78 can be controlled by the low-speed bridge circuit 66 to provide the expanding I/O ports 79a, 79b and 79c. The SOC 52 can use the internal low-speed bridge circuit 66 or the external expanding bridge circuit 78 selectively.

The expanding bridge circuit 78 shown in FIG. 2 can also be applied in a south bridge circuit of x86 architecture. Generally speaking, the south bridge circuit supports a plurality of I/O ports, such as a serial port, a parallel port, six USB ports and two IEEE 1394 ports. The expanding bridge circuit 78 and the high-speed bridge circuit 64 of the SOC 52 can be connected using any bus connector to transmit data. For example, a PCI bus or a V-link bus can be used according to the present invention.

In order to illustrate the features of the present invention, the low-speed bridge circuit 66 is simplified to support only one I/O port 56, and the expanding bridge circuit 78 is simplified to support only three I/O ports 79a, 79b and 79c. However, it is appreciated that the low-speed bridge circuit 66 supports m I/O ports, the expanding bridge circuit 78 supports n I/O ports, and n is greater than m according to the present invention. Therefore, when the expanding bridge circuit 78 is used to expand the functionality of the low-speed bridge circuit 66, a greater number of applicable I/O ports than that of the original applicable I/O ports can be obtained. In addition, the display driving circuit 68 is located within the SOC 52 according to the present embodiment. However, the display driving circuit 68 can be integrated to within the high-speed bridge circuit 64 or the CPU 62. Alternatively, an independent display chip externally connected to the SOC 52 is also applicable, and thus the SOC 52 does not include the display driving circuit 68.

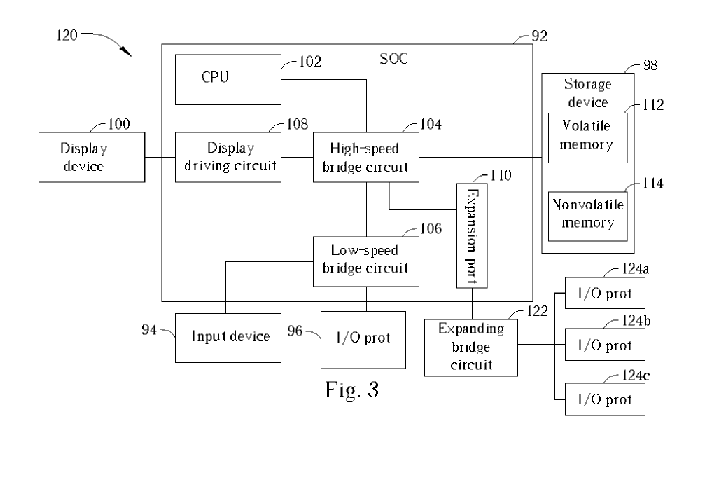

Please refer to FIG. 3 of a schematic diagram of another SOC applied in an embedded system according to the present invention. An embedded system 120 includes an SOC 92, an input device 94, an I/O port 96, a storage device 98, a display device 100, an expanding bridge circuit 122, and a plurality of I/O ports 124a, 124b, and 124c. The SOC 92 includes a CPU 102, a high-speed bridge circuit 104, a low-speed bridge circuit 106, a display driving circuit 108 and an expansion port 110. In addition, the storage device 98 includes a volatile memory 112 and a nonvolatile memory 114. The elements having the same names in the embedded system 120 and in the embedded system 80 shown in FIG. 2 are supposed to have the same functions. The difference between the embedded system 120 and the embedded system 80 is that the embedded system 120 does not use a multiplexer, and the expansion port 110 is connected to the high-speed bridge circuit 104 and the expanding bridge circuit 122 directly.

Since the expansion port 110 is connected to the high-speed bridge circuit 104, the expanding bridge circuit 122 is connected to the high-speed bridge circuit 104 to facilitate data transmission between the expanding bridge circuit 122 and the high-speed bridge circuit 104. The expanding bridge circuit 122 supports a plurality of I/O ports 124a, 124b, and 124c. The internal low-speed bridge circuit 106 of the SOC 92 also supports the I/O port 96. Therefore, the embedded system 120 can use these I/O ports 96, 124a, 124b and 124c to connect to a plurality of external devices to expand its functionality. For example, when the embedded system 120 is applied in a PDA which supports four USB ports to connect to external devices, such as a printer, the expansion port 110 in the SOC 92 has to be connected to the expanding bridge circuit 122 to provide the I/O ports 96, 124a, 124b, 124c as the four USB ports.

Generally speaking, the low-speed bridge circuit of the embedded system only supports an I/O port. Therefore, when the SOC 92 is applied in the embedded system 120, which has the I/O port 96, the internal low-speed bridge circuit 106 of the SOC 92 can be used to control the external device connected to the I/O port 96. When a plurality of I/O ports are required by the embedded system 120, the external expanding bridge circuit 122 can be used to support the I/O ports 124a, 124b and 124c.

In addition, the expanding bridge circuit 122 can also be applied in a south bridge circuit of x86 architecture. The expanding bridge circuit 122 and the high-speed bridge circuit 104 of the SOC 92 can be connected using any bus connector to transmit data. For example, a PCI bus or a V-link bus can be used according to the present invention.

In order to illustrate the features of the present invention, the low-speed bridge circuit 106 is simplified to support only one I/O port 96, and the expanding bridge circuit 122 is simplified to support only three I/O ports 124a, 124b and 124c. If the internal low-speed bridge circuit 106 supports m I/O ports and the external expanding bridge circuit 122 supports n I/O ports, a greater number m+n of applicable I/O ports than the number m of the original applicable I/O ports can be obtained using the expanding bridge circuit 122. Therefore, the functionality of the low-speed bridge circuit 106 within the SOC 92 can be expanded, and the SOC 92 can be used in the embedded systems having different demands for I/O ports.

According to the present embodiment, the display driving circuit 108 is located within the SOC 92. However, the display driving circuit 108 can be integrated to within the high-speed bridge circuit 104 or the CPU 102. Alternatively, an independent display chip externally connected to the SOC 92 is also applicable, and thus the SOC 92 does not include the display driving circuit 102.

In contrast to the prior art, the SOC of the present invention has an RISC CPU, a high-speed bridge circuit, a low-speed bridge circuit and an expansion port. According to the design demands of the embedded system, the expansion port can be selectively connected to an external expanding bridge circuit, thus expanding the functionality of the low-speed bridge circuit located within the SOC. The external expanding bridge circuit can be connected to the SOC using a known PCI bus or a V-link bus. Therefore, the SOC can be applied in the embedded systems having different hardware demands according to the present invention. Since all the circuits in the SOC are not changed, redesign or re-manufacture is not required for the SOC to be applied in different embedded systems. As a result, costs for manufacturing the SOC can be significantly reduced.

Those skilled in the art will readily observe that numerous modifications and alterations of the device may be made while retaining the teachings of the invention. Accordingly, the above disclosure should be construed as limited only by the metes and bounds of the appended claims.

1. An SOC comprising:
a processor for controlling operation of the SOC;
a high-speed bridge circuit connected to the processor, the high-speed bridge circuit being used to control signal transmission between the processor and a high-speed peripheral device connected to the high-speed bridge circuit;
a low-speed bridge circuit connected to the high-speed bridge circuit, the low-speed bridge circuit being used to control signal transmission between the high-speed bridge circuit and a first low-speed peripheral device connected to the low-speed bridge circuit; and
an expansion port connected to the high-speed bridge circuit, the expansion port being used to connect to an expanding bridge circuit, the expanding bridge circuit being externally connected to the SOC and controlling signal transmission between the high-speed bridge circuit and at least a second low-speed peripheral device connected to the expanding bridge circuit.

2. The SOC of claim 1 wherein the processor comprises a RISC processor.

3. The SOC of claim 1 further comprising:
a multiplexer comprising:
an input connected to the expansion port;
a first output connected to the high-speed bridge circuit; and
a second output connected to the low-speed bridge circuit.

4. The SOC of claim 3 wherein the multiplexer connects the input and the first output when the expanding bridge circuit is connected to the expansion port.

5. The SOC of claim 3 wherein the expansion port is selectively connected to an input/output port of the SOC or to the expanding bridge circuit.

6. The SOC of claim 5 wherein the multiplexer connects the input and the second output when the expansion port is connected to the input/output port.

7. The SOC of claim 1 wherein the low-speed bridge circuit is connected to a first input/output port, and the expanding bridge circuit is connected to a second input/output port; wherein the first input/output port is used to connect to the first low-speed peripheral device, and the second input/output port is used to connect to the second low-speed peripheral device.

8. The SOC of claim 1 wherein the expansion port is connected to the expanding bridge circuit using a bus connector.

9. The SOC of claim 8 wherein the bus connector comprises a V-link bus.

10. The SOC of claim 8 wherein the bus connector comprises a PCI bus.

11. The SOC of claim 1 wherein the expanding bridge circuit comprises a south bridge circuit of x86 architecture.

12. The SOC of claim 1 wherein the SOC is installed in a package, and the expansion port comprises a plurality of pinouts of the package.

13. The SOC of claim 1 wherein the SOC is utilized in an embedded system.
